(19) United States
(12) Patent Application Publication
(10) Pub. No.: US 2009/0092397 A1
(43) Pub. Date: Apr. 9, 2009

(54) WIRELESS REMOTE CONTROL DEVICE, BRIDGE DEVICE AND WIRELESS REMOTE CONTROL SYSTEM

(76) Inventor: Kohichi TAGUCHI, Osaka (JP)

Correspondence Address: NIXON & VANDERHYE, PC, 901 NORTH GLEBE ROAD, 11TH FLOOR, ARLINGTON, VA, 22203, US

(21) Appl. No.: 12/243,252

(22) Filed: Oct. 1, 2008

(30) Foreign Application Priority Data
Oct. 3, 2007 (JP) 2007-259890

(51) Int. Cl. H04B 10/00

(52) U.S. Cl. 398/106

(57) ABSTRACT

A wireless remote control device of the present invention includes not only an infrared-transmitting section that transmits operational information to the outside so as to remotely control a predetermined electronic device but also a radio-wave-transmitting section that transmits information to the outside through the use of radio waves as a medium. Thus, it is easily possible to remotely control an electronic device such as audio-visual equipment and to transmit operational information in the form of radio waves with a higher degree of accuracy.

### CROSS-REFERENCE TO RELATED APPLICATION

This nonprovisional application claims priority under 35 U.S.C. § 119 (a) on Patent Application No. 2007-259890 filed in Japan on Oct. 3, 2007, the entire contents of which are hereby incorporated by reference.

### BACKGROUND OF THE INVENTION

1. Field of the Invention

The present invention relates to a wireless remote control device for remotely controlling an electronic device such as audio-visual equipment, a bridge device for use with such a wireless remote control device and a wireless remote control system incorporating these devices.

2. Description of Related Art

Conventionally, wireless remote control devices (hereinafter also simply called “remote control devices”) for remotely controlling electronic devices such as audio-visual equipment are widely used. In these remote control devices, infrared rays or the like is widely used as a medium through which to transmit operational information to the electronic devices. Documents on conventional technologies related to these devices include JP-A-2002-247667 and JP-A-2000-152347.

With the remote control device mentioned above, however, since infrared rays have a higher degree of linear propagation than other radio waves, when there is an obstruction between the remote control device and an infrared-receiving section in an electronic device, it is highly likely that the electronic device is prevented from being remotely controlled.

In some cases, in order to prevent an erroneous operation (such as an operation of a device that is not intended to be operated) caused by a remote control device, the degree of linear propagation of infrared rays emitted is enhanced (specifically, infrared rays are prevented from being emitted at wide angles) such that an erroneous operation is less likely to be caused by reflected light. In a case where a television broadcast receiver is remotely controlled, when, for example, a user attempts to operate it by directing a remote control device toward the middle of its screen, it may be difficult for one infrared-receiving section to receive an operational signal without fail partly because larger screens are increasingly used. Under these circumstances, it may be more difficult to achieve operational-information transmission in which infrared rays are used as a medium.

Remote control devices are available that have a plurality of infrared LEDs for transmission of operational information so as to emit infrared rays in different directions; electronic devices are available that are remotely controlled and are provided with a plurality of infrared-receiving sections. However, situations still arise where infrared rays are not reached and thus remote control is not achieved. In DVD playback devices, for example, when they are placed inside a television rack (in some cases, inside a rack covered with a door of smoked glass) or the like, it may be difficult to achieve operational-information transmission with infrared rays.

### SUMMARY OF THE INVENTION

An object of the present invention is to provide a remote control device that remotely controls an electronic device such as audio-visual equipment and easily allows wireless transmission of operational information with a higher degree of accuracy, and to provide a bridge device for use with such a remote control device and a wireless remote control system incorporating these devices.

To achieve the above object, according to one aspect of the invention, there is provided a wireless remote control device including: an infrared-transmitting section transmitting operational information in the form of infrared rays to the outside so as to remotely control an electronic device; and a radio-wave-transmitting section transmitting information to the outside through use of radio waves as a medium.

With this configuration, since the radio-wave-transmitting section is provided, it is easily possible not only to transmit the operational information in the form of infrared rays through the use of the infrared-transmitting section but also to transmit the operational information in the form of radio waves. This makes it easier to transmit to the electronic device the operational information in the form of radio waves with a high degree of accuracy as compared with a wireless remote control device that simply performs infrared transmission.

In the wireless remote control device configured as described above, the radio-wave-transmitting section may transmit the operational information in the form of radio waves to the outside.

With this configuration, it is easily possible to transmit to the electronic device the operational information in the form of radio waves with a higher degree of accuracy. In the “operational information” mentioned here, there is no limitation on the form thereof, and for example, the operational information in the form of an infrared code is included.

In the wireless remote control device configured as described above, a user may select, as appropriate, one of the infrared-transmitting section and the radio-wave-transmitting section so that the operational information is transmitted therewith.

With this configuration, the user can determine which one of the infrared-transmitting section and the radio-wave-transmitting section should be used for transmitting the operational information, and thus the operational information can be transmitted based on the result of the determination. Thus, it is possible to perform transmission that is more suitable for a particular situation.

The wireless remote control device configured as described above may have an operational-information-generating section generating the operational information based on information entered by the user. Here, the infrared-transmitting section and the radio-wave-transmitting section may receive the operational information generated by the operational-information-generating section.

With this configuration, it is possible to perform processing with high efficiency as compared with a wireless remote control device in which operational information is separately generated for each of transmitting sections.

According to another aspect of the invention, there is provided a bridge device including: a receiving section receiving the operational information transmitted in the form of radio waves from the wireless remote control device configured as described above; and a transfer section transferring the received operational information to the electronic device through use of infrared rays as a medium.

With this configuration, it is possible to transfer the operational information transmitted in the form of radio waves from the wireless remote control device to an electronic device that can receive infrared rays. Thus, it is possible to enter the operational information transmitted in the form of radio waves from the wireless remote control device into an electronic device that has no capability of receiving radio waves.

The bridge device configured as described above may include a reception-detecting section detecting whether or not the operational information transmitted in the form of radio waves is received. Here, the bridge device may switch modes of supply of electric power for driving a circuit incorporated therein according to a result of detection by the reception-detecting section.

With this configuration, it is easily possible to maintain a so-called low power consumption mode while in a standby mode and return mode of supply of electric power for driving the circuit to a normal mode when the operational information is received. Thus, it is possible to reduce wasteful power consumption as much as possible.

According to another aspect of the invention, there is provided a wireless remote control system that includes the wireless remote control device configured as described above and the bridge device configured as described above.

With this configuration, it is possible to gain advantages of the above-described second and fifth configurations. It is also possible not only to transmit the operational information from the wireless remote control device directly to the electronic device but also to transmit it via the bridge device.

In the wireless remote control system configured as described above, the bridge device may include a first-type-of-information-transmitting section that transmits, when receiving the operational information in the form of radio waves from the wireless remote control device, a predetermined first type of information to the wireless remote control device, and the wireless remote control device may produce, when receiving the first type of information, a predetermined sound or a predetermined type of light.

With this configuration, it is possible to notify the user, through the use of the wireless remote control device, that the operational information is successfully transmitted in the form of radio waves from the wireless remote control device to the bridge device. Thus, it is possible to minimize the occurrence of a situation where the user overlooks the fact that the radio wave transmission is unsuccessful.

In the wireless remote control system configured as described above, the bridge device may include a second-type-of-information-transmitting section that transmits, according to an instruction of the user, a predetermined second type of information to the wireless remote control device through the use of radio waves as a medium, and the wireless remote control device may produce, when receiving the second type of information, a predetermined sound or a predetermined type of light.

With this configuration, for example, even when the current position of the wireless remote control device becomes unknown, it is possible to allow the wireless remote control device to notify the user of the current position by giving a predetermined instruction to the wireless remote control device. This makes it easier for the user to find the wireless remote control device. Since the second type of information is transmitted through the use of radio waves as a medium, even if there is an obstruction between the wireless remote control device and the bridge device, the interference of transmission is minimized.

The bridge device that receives the operational information transmitted in the form of radio waves from the wireless remote control device configured as described above may be configured such that the bridge device is incorporated into the electronic device and the bridge device feeds the received operational information to a circuit inside the electronic device.

With this configuration, for example, the bridge device is incorporated into an electronic device that can receive operational information in the form of infrared rays but cannot receive it in the form of radio waves, and thus even when the operational information is transmitted in the form of either infrared rays or radio waves from the wireless remote control device, the operational information can be entered into the electronic device.

An electronic device that gains advantages of the bridge device configured as described above is formed by incorporating the bridge device configured as described above into the electronic device.

### BRIEF DESCRIPTION OF THE DRAWINGS

The above object and other objects and features of the present invention will be apparent from the following description of preferred embodiments with reference to the accompanying drawings listed below.

FIG. 1 is a diagram schematically showing the configuration of a television broadcast receiving system according to a first embodiment of the present invention;

FIG. 2 is a diagram showing the configuration of a remote control device according to the embodiment of the invention;

FIG. 3 is a diagram showing the configuration of a bridge device according to the first embodiment of the invention;

FIG. 4 is a diagram showing the flow of main processing in the embodiment of the invention;

FIG. 5 is a diagram schematically showing the configuration of a television broadcast receiving system according to a second embodiment of the invention; and

FIG. 6 is a diagram showing the configuration of a bridge device according to the second embodiment of the invention.

### DETAILED DESCRIPTION OF PREFERRED EMBODIMENTS

First and second embodiments will be described below as embodiments of the present invention.

### First Embodiment

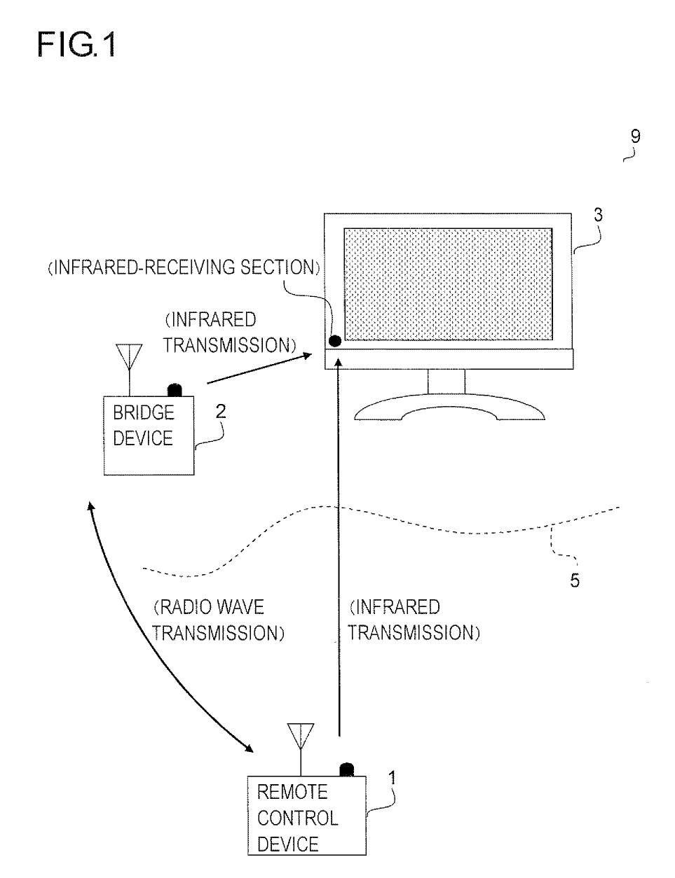

A television broadcast receiving system will be described below as the first embodiment of the invention. The configuration of the television broadcast receiving system is schematically shown in FIG. 1. As shown in the figure, the television broadcast receiving system 9 has a remote control device 1, a bridge device 2 and a television broadcast receiver 3.

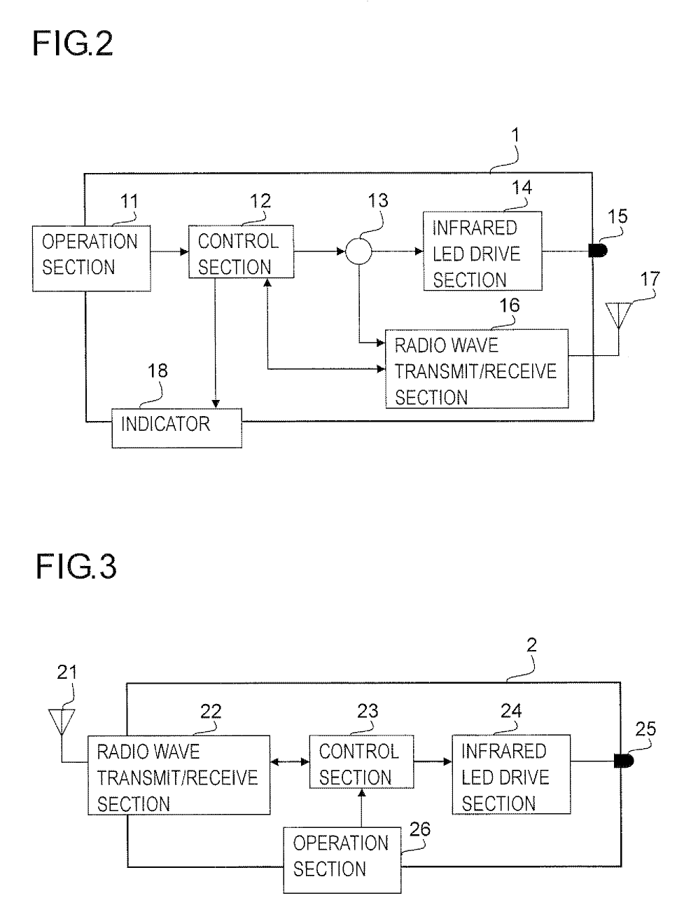

The remote control device 1 includes, as shown in FIG. 2, an operation section 11, a control section 12, a switch 13, an infrared LED drive section 14, an infrared LED 15, a radio wave transmit/receive section 16, an antenna 17 and an indicator 18.

The operation section 11 is configured to serve as a user interface provided with push-button switches and other controls. A signal (an operational signal) corresponding to an operation performed here is fed to the control section 12. Thus, a user can enter operational information (for example, information on operations such as the turning on and off of power and the switching of reception channels) for the television broadcast receiver 3 by operating the operation section 11. By operating the operation section 11, the user can select, as appropriate, one of two methods, namely, an infrared-transmission method and a radio-wave-transmission method, of transmitting the operational information to the outside.

The control section 12 is formed by, for example, a MPU (micro processing unit); it controls various types of processing performed in the remote control device 1. The control section 12 also decodes the operational signal fed from the operation section 11 and produces an infrared code (a signal for driving the infrared LED so that the operational information is transmitted in the form of infrared rays) corresponding to the operational information. The main processing will be specifically described later.

The switch 13 switchably connects the output path of the infrared code produced in the control section 12 to either of the infrared LED drive section 14 and the radio wave transmit/receive section 16. As described previously, this switching operation is performed in advance in the operation section 11 by the user. Thus, it is possible to feed, through the switching operation, the infrared code produced in the control section 12 and corresponding to the operational information to either the infrared LED drive section 14 or the radio wave transmit/receive section 16. This makes it easier to form (that is, integrate), by use of only a device equivalent to the control section 12, a device that produces and feeds the infrared code to the infrared LED drive section 14 and a device that produces and feeds the infrared code to the radio wave transmit/receive section 16. Thus, it is possible to easily achieve processing with high efficiency as compared with the remote control device 1 in which these devices are provided separately.

The infrared LED drive section 14 drives the infrared LED 15 so that the operational information is transmitted in the form of infrared rays based on the infrared code fed from the control section 12. This allows the infrared LED 15 to transmit the operational information in the form of infrared rays to the outside.

In the radio wave transmit/receive section 16, the infrared code fed from the control section 12 is subjected, as appropriate, to processing such as amplification and modulation and is emitted in the form of radio waves via the antenna 17 to the outside. That is, the infrared code (the same signal as that for driving the infrared LED) is emitted in the form of radio waves to the outside. The processing performed here may be triggered by the infrared code fed from the control section 12. The radio wave transmit/receive section 16 also serves to receive a radio signal transmitted from the bridge device 2 via the antenna 17.

The indicator 18 has a speaker (a sound output device) and a lamp (a light emitting device), and performs predetermined processing for sound output and light emission according to instructions from the control section 12. Thus, the remote control device 1 can notify the user of various types of information (such as information that allows the user to notice a given timing or the current position of the remote control device 1).

The bridge device 2 includes, as shown in FIG. 3, an antenna 21, a radio wave transmit/receive section 22, a control section 23, an infrared LED drive section 24, an infrared LED 25 and an operation section 26.

The radio wave transmit/receive section 22 is connected to the antenna 21 and communicates with the remote control device 1 by radio waves. More specifically, the bridge device 2 receives, via the antenna 21, the signal (that obtained by modulating the infrared code) transmitted in the form of radio waves from the remote control device 1, and feeds it to the control section 23. The radio wave transmit/receive section 22 also receives information that is produced by the control section 23 in order to be transmitted to the remote control device 1, and transmits the information in the form of radio waves to the remote control device 1 via the antenna 21.

The control section 23 is formed by, for example, a MPU; it controls various types of processing performed in the bridge device 2. The control section 23 also demodulates the signal transmitted in the form of radio waves from the remote control device 1 into the infrared code corresponding to the operational information, and feeds it to the infrared LED drive section 24 in the succeeding stage. The main processing will be specifically described later.

The infrared LED drive section 24 drives the infrared LED 25 so that the operational information is transmitted in the form of infrared rays based on the infrared code fed from the control section 23. In this way, the infrared LED 25 transmits the operational information in the form of infrared rays to the outside.

The operation section 26 is configured to serve as a user interface provided with push-button switches and other controls. When the user pushes a button or performs other operations, the operation section 26 feeds the corresponding information to the control section 23.

The television broadcast receiver 3 has the same functions as those of a common television broadcast receiver, and receives television broadcast to produce video and audio outputs of a television program. In addition, the television broadcast receiver 3 has an infrared receiving section to receive information (especially the operational information) that is transmitted, by use of infrared rays as a medium, from the outside (especially from the remote control device 1 or the bridge device 2).

The television broadcast receiving system 9 is designed on the assumption that: the bridge device 2 is arranged so as to communication with the television broadcast receiver 3 by infrared rays, that is, the bridge device 2 is arranged such that infrared rays emitted from the infrared LED 25 can reach the infrared receiving section in the television broadcast receiver 3; and the remote control device 1 is used within an area that allows communication with the bridge device 2 by radio waves, and more preferably, the remote control device 1 is used within an area that allows communication with the television broadcast receiver 3 by infrared rays under normal conditions (in which there is no obstruction 5 or the like).

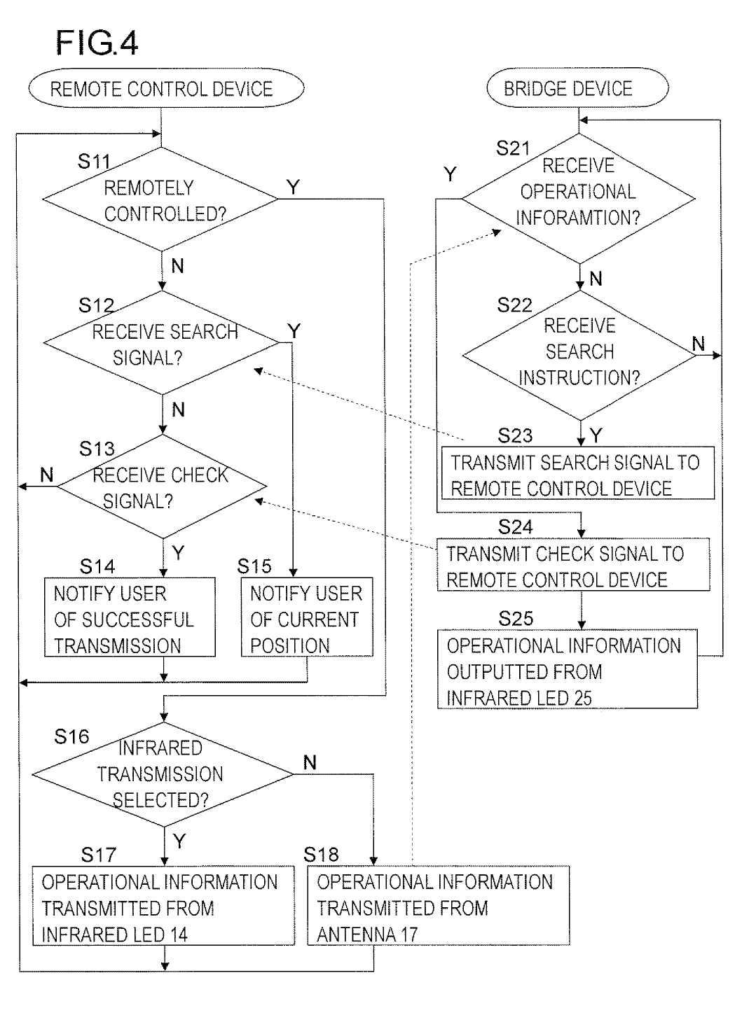

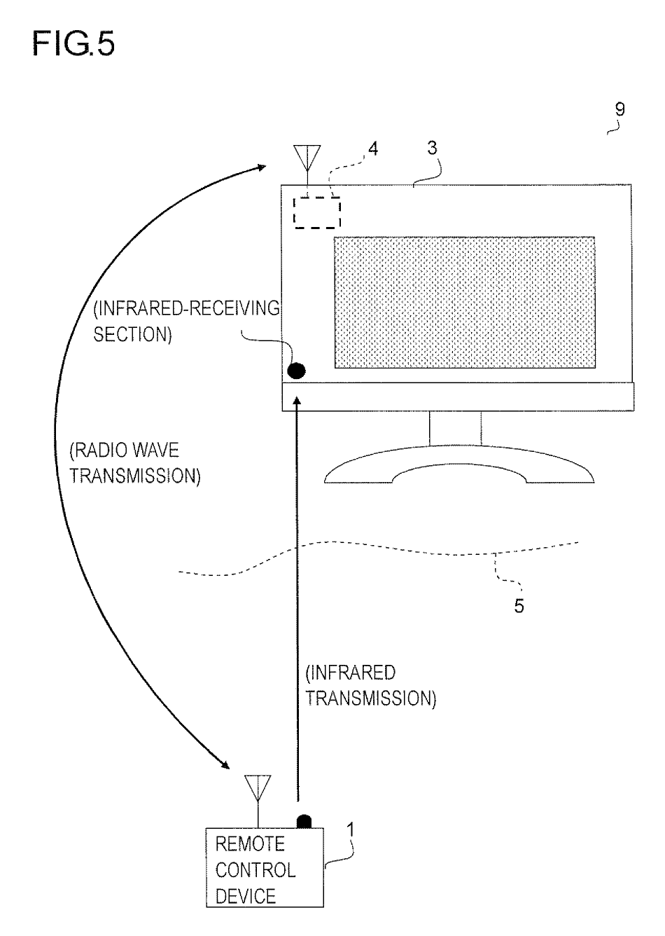

The flow of main processing performed in the television broadcast receiving system 9 will now be described with reference to a flowchart shown in FIG. 4.

The remote control device 1 normally monitors whether or not it is operated by the user through the use of the operation section 11 (whether or not the user enters operational information) (step S11). The remote control device 1 also monitors whether or not it receives a search signal from the bridge device 2 (step 12) and whether or not it receives a check signal (step 13). As described later, “the search signal” is used in processing that facilitates the searching of the current position of the remote control device 1 and “the check signal” is used in processing that facilitates the checking of whether communication is successfully performed by radio waves.

If the remote control device 1 is operated (Y in step S11), the control section 12 decodes a signal obtained by the operation of the remote control device 1, produces an infrared code (hereinafter also simply called “operational information”) corresponding to the operational information and feeds it to the switch 13. Then, if infrared transmission is selected in advance as a method for transmitting the operational information (Y in step S16), the operational information is fed to the infrared LED drive section 14 and is transmitted in the form of infrared rays to the outside by the infrared LED 15 (step S17).

If radio wave transmission is selected as the method for transmitting operational information (N in step S16), the operational information is fed to the radio wave transmit/receive section 16 and is transmitted in the form of radio waves to the outside via the antenna 17 (step S18).

If the search signal is received (Y in step S12), the control section 12 allows the speaker and the lamp in the indicator 18 to produce a predetermined sound and a predetermined type of light. It is not necessary to produce both the sound and the light; only one of them may be produced. Thus, the user is notified of the current position of the remote control device 1 (step S15).

If the check signal is received (Y in step S13), the control section 12 allows the speaker and the lamp in the indicator 18 to produce a predetermined sound and a predetermined type of light. It is not necessary to produce both the sound and the light; only one of them may be produced. Thus, the user is notified that the radio wave transmission is achieved (step S14). The speaker and lamp used in step 14 may be used in step 15 or a speaker and a lamp different from those used in step 14 may be used in step 15.

The bridge device 2 monitors whether or not the operational information transmitted in the from of radio waves from the remote control device 1 is received (step S21). The bridge device 2 also monitors whether or not the user instructs that search processing be performed (step S22). By performing a predetermined operation in the operation section 26, the user can instruct that the search processing be performed.

If the operational information is received (Y in step S21), the control section 23 produces and feeds a predetermined check signal to the radio wave transmit/receive section 22. Then, the check signal is transmitted in the form of radio waves to the remote control device 1 by the radio wave transmit/receive section 22 (step S24).

The control section 23 feeds the received operational information to the infrared LED drive section 24. Then, the operational information is transmitted in the form of infrared rays to the television broadcast receiver 3 by the infrared LED 25 (step S25). If the control section 23 is instructed that the search processing be preformed (Y in step S22), the control section 23 produces and feeds a predetermined search signal to the radio wave transmit/receive section 22.

The television broadcast receiver 3 receives the operational information that is transmitted in the form of infrared rays in step S17 or step S25 described above, and performs processing corresponding to this operational information. In this way, the television broadcast receiver 3 is remotely controlled by the operation of the remote control device 1.

With the television broadcast receiving system 9 described above, the user can remotely control the television broadcast receiver 3 by selecting in advance the infrared transmission as the method for transmitting operational information from the remote control device 1 and then operating the remote control device 1. Like a common television broadcast receiving system, operational information is transmitted from the remote control device 1 to the space (infrared transmission) and then to the television broadcast receiver 3, with the result that remote control is achieved.

In the transmission in which such a transmission route is employed, however, when, for example, there is an obstruction 5 between the remote control device 1 and the television broadcast receiver 3 as shown in FIG. 1, the infrared transmission is blocked and thus there is a possibility that the remote control is not achieved. In such a case, the user can remotely control the television broadcast receiver 3 by selecting in advance the radio wave transmission as the method for transmitting operational information from the remote control device 1. Specifically, operational information is transmitted from the remote control device 1 to the space (radio wave transmission) to the bridge device 2 to the space (infrared transmission) and then to the television broadcast receiver 3, with the result that remote control is achieved.

Since radio waves have a lower degree of linear propagation than infrared rays (light rays), even if there is an obstruction between the remote control device 1 and the bridge device 2, it is much less likely that radio wave transmission therebetween is blocked. Hence, with the television broadcast receiving system 9, it is possible to remotely control the television broadcast receiver 3 with a higher degree of accuracy through the use of the remote control device 1.

Systems have already been widely used in which a television broadcast receiver is provided with an infrared receiving section and is remotely controlled with infrared rays emitted from a remote control device. The television broadcast receiving system 9 of this embodiment can be formed simply by providing an additional remote control device 1 and an additional bridge device 2 to such a conventional system (that is, there is no need to provide an additional television broadcast receiver 3 or change the design of the conventional television broadcast receiver). Thus, it is relatively easy to make the television broadcast receiving system 9 of this embodiment widely available through the use of the television broadcast receiver in the conventional system.

In daily life, a remote control device is likely to be missing (its current position is unknown) because, for example, the remote control device is left somewhere or it is covered by a cushion. Even in such a case, with the television broadcast receiving system 9, the user can instruct the bridge device 2 to conduct a search (Y in step S22), and this allows the remote control device 1 to produce a predetermined sound and a predetermined type of light (step S15). This helps the user find the missing remote control device 1 with ease.

When operational information is transmitted in the form of radio waves from the remote control device 1 to the bridge device 2, it is convenient for the user to be able to check, with the remote control device 1, whether such transmission is successfully performed. For this purpose, in the television broadcast receiving system 9, when operational information is received, a check signal is transmitted in the form of radio waves from the bridge device 2 (step S24) and thus the remote control device 1 produces a predetermined sound and a predetermined type of light (step S14). In this way, the user can check, with the remote control device 1, that operational information is successfully transmitted in the form of radio waves.

The bridge device 2 may be designed such that while in a standby mode (while it monitors reception of operational information and a search instruction), the bridge device 2 is kept in a low power consumption mode, and when the bridge device 2 receives operational information from the remote control device 1, it enters a normal mode. More specifically, for example, while in a standby mode, the bridge device 2 is operated in a mode in which its power consumption (the amount of power supplied for driving a circuit included in the bridge device 2) is minimized to such an extent that whether or not operational information is received (step S21) and whether or not a search instruction is received (step S22) can be monitored (for example, can periodically be checked). When operational information or a search instruction is received, the bridge device 2 returns to a normal mode (where a normal amount of power is consumed).

In this way, it is possible to reduce power consumption as compared with the case where the bridge device 2 always consumes a normal amount of power. In particular, in a case where the remote control device 1 frequently controls the television broadcast receiver 3 directly in a remote manner without the need for the bridge device 2 (in a case where the bridge device 2 is almost always kept in a standby mode), the amount of power consumption can be reduced significantly.

### Second Embodiment

Likewise, a television broadcast receiving system will be described below as the second embodiment of the invention. The configuration of the television broadcast receiving system is schematically shown in FIG. 5. As shown in the figure, the television broadcast receiving system 9 has a remote control device 1 and a television broadcast receiver 3. In this embodiment, since the configuration of the remote control device 1, the details of operational information and the like are the same as those in the first embodiment, their description will not be repeated.

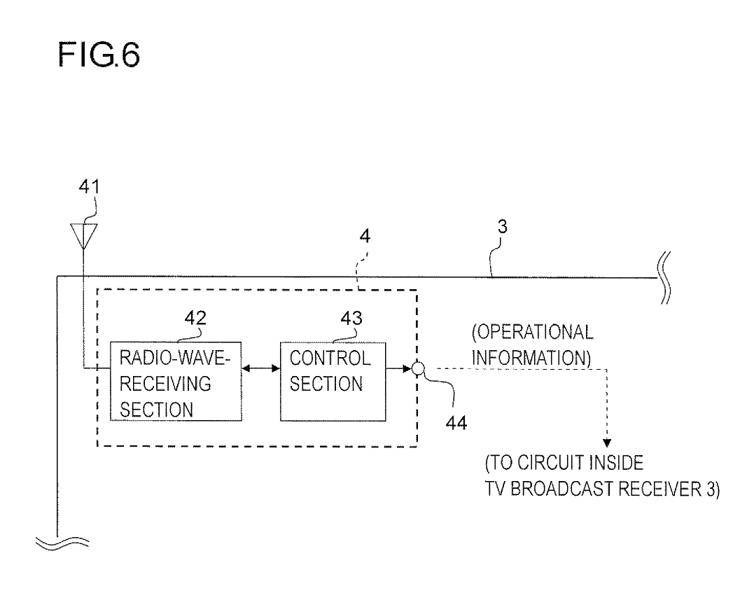

A bridge device 4 of this embodiment is incorporated into the television broadcast receiver 3 as a component (module) thereof. The configuration of the bridge device 4 is shown in FIG. 6. As shown in the figure, the bridge device 4 includes an antenna 41, a radio wave receiving section 42, a control section 43 and an output terminal 44.

The radio wave receiving section 42 is connected to the antenna 41 and receives operational information transmitted in the form of radio waves from the remote control device 1. The control section 43 controls different types of processing performed in the bridge device 4. The control section 43 feeds the operational information received in the radio wave receiving section 42 to a circuit inside the television broadcast receiver 3 via the output terminal 44. Thus, the television broadcast receiver 3 receives the operational information to perform processing corresponding to this operational information.

Since the bridge device 4 is incorporated into the television broadcast receiver 3 as described above, one of infrared transmission and radio wave transmission can be selected, as appropriate, as a method for transmitting operational information from the remote control device 1 to the television broadcast receiver 3. Thus, as in the first embodiment, the television broadcast receiver 3 can be remotely controlled with a high degree of accuracy through the use of the remote control device 1 as compared with the case where infrared transmission alone is employed as a transmission method.

The bridge device 4 may be designed to perform the search processing or the like described in the first embodiment. Instead of the control section 43 being provided, the bridge device 4 may be controlled by a control signal that is inputted from a control device in the television broadcast receiver 3.

Although the embodiments of the present invention are described above, the invention is not limited to these embodiments. Many variations and modifications are possible without departing from the spirit of the invention. Although in the embodiments, the television broadcast receiver is described as an example of an operational-information receiving electronic device, various other types of electronic devices, especially audio-visual equipment such as a DVD record/playback device can be applied.

With one of the above-described wireless remote control devices according to the embodiments of the invention, since it has a radio-wave-transmitting section, it is easily possible not only to transmit operational information in the form of infrared rays through the use of an infrared-transmitting section but also to transmit the operational information in the form of radio waves. This makes it easier to transmit to an electronic device operational information in the form of radio waves with a high degree of accuracy as compared with a wireless remote control device that simply performs infrared transmission.

What is claimed is:

1. A wireless remote control device comprising:
an infrared-transmitting section transmitting operational information in a form of infrared rays to outside so as to remotely control an electronic device; and
a radio-wave-transmitting section transmitting information to outside through use of radio waves as a medium.

2. The wireless remote control device of claim 1,
wherein the radio-wave-transmitting section transmits the operational information in a form of radio waves to outside.

3. The wireless remote control device of claim 2,
wherein a user can select, as appropriate, one of the infrared-transmitting section and the radio-wave-transmitting section so that the operational information is transmitted therewith.

4. The wireless remote control device of claim 3, further comprising:
an operational-information-generating section generating the operational information based on information entered by the user,
wherein the infrared-transmitting section and the radio-wave-transmitting section receive the operational information generated by the operational-information-generating section.

5. A bridge device comprising:
a receiving section receiving the operational information transmitted in the form of radio waves from the wireless remote control device of claim 2; and
a transfer section transferring the received operational information to the electronic device through use of infrared rays as a medium.

6. The bridge device of claim 5, further comprising:
a reception-detecting section detecting whether or not the operational information transmitted in the form of radio waves is received,
wherein the bridge device switches modes of supply of electric power for driving a circuit incorporated therein according to a result of detection by the reception-detecting section.

7. A wireless remote control system comprising:
the wireless remote control device of claim 2; and
the bridge device of claim 5.

8. The wireless remote control system of claim 7,
wherein the bridge device includes a first-type-of-information-transmitting section that transmits, when receiving the operational information in the form of radio waves from the wireless remote control device, a predetermined first type of information to the wireless remote control device, and the wireless remote control device produces, when receiving the first type of information, a predetermined sound or a predetermined type of light.

9. The wireless remote control system of claim 7,
wherein the bridge device includes a second-type-of-information-transmitting section that transmits, according to an instruction of a user, a predetermined second type of information to the wireless remote control device through use of radio waves as a medium, and the wireless remote control device produces, when receiving the second type of information, a predetermined sound or a predetermined type of light.

10. A bridge device receiving the operational information transmitted in the form of radio waves from the wireless remote control device of claim 2,
wherein the bridge device is incorporated into the electronic device, and the bridge device feeds the received operational information to a circuit inside the electronic device.

11. An electronic device,
wherein the bridge device of claim 10 is incorporated.
